(19) United States
(12) Patent Application Publication
(10) Pub. No.: US 2022/0146909 A1
(43) Pub. Date: May 12, 2022

(54) CONTROLLING DETACHABLE CAMERA DEVICES

(71) Applicant: Hewlett-Packard Development Company, L.P., Spring, TX (US)

(72) Inventors: Yi-Hsuan Huang, Taipei City (TW); Yi-Lin Lee, Taipei City (TW); Chia Hua Chu, Taipei City (TW)

(73) Assignee: Hewlett-Packard Development Company, L.P., Spring, TX (US)

(21) Appl. No.: 17/419,777

(22) PCT Filed: Jul. 31, 2019
(86) PCT No.: PCT/US2019/044516

§ 371 Date: Jun. 30, 2021

(51) Int. Cl. G03B 17/04; H04N 5/225; H04N 5/232

(52) U.S. Cl. CPC G03B 17/04; H04N 5/23216; H04N 5/2258; H04N 5/2256

(57) ABSTRACT

Examples of control of detachable camera devices are discussed. A detachable camera device may include a camera and an illumination module. Based on user inputs provided on an apparatus to which the device is detachably coupled, the position of the camera and the intensity of light provided by the illumination module can be changed. The device may include a controller to receive the user inputs from the apparatus and control the camera and the illumination module.

### BACKGROUND

Detachable cameras, such as webcams, may be used with apparatuses, such as, computing devices and laptops, to capture images, for example, for presentation of objects, for video calls, and the like. Images captured by a detachable camera device may be transferred to the associated apparatus for display or for further processing. Detachable camera devices may also include light sources to provide light, for example, when images are to be captured in a low-light environment.

### BRIEF DESCRIPTION OF DRAWINGS

The following detailed description references the figures, wherein:

FIG. 1 illustrates a schematic of an example detachable camera device, according to an example implementation of the present subject matter;

FIG. 2(a) illustrates a front view of an example detachable camera device, according to an example implementation of the present subject matter;

FIG. 2(b) illustrates a side view of the example detachable camera device, according to an example implementation of the present subject matter;

FIG. 2(c) illustrates the detachable camera device coupled to an apparatus, according to an example implementation of the present subject matter;

FIG. 2(d) illustrates a first position of an example detachable camera device disposed on an apparatus, according to another example implementation of the present subject matter;

FIG. 2(e) illustrates a second position of an example detachable camera device disposed on an apparatus, according to another example implementation of the present subject matter;

FIG. 3(a) illustrates a schematic of a set of cameras of a detachable camera device, according to another example implementation of the present subject matter;

FIG. 3(b) illustrates an example drive system of a detachable camera device, according to an example implementation of the present subject matter;

FIG. 4 illustrates an example apparatus to control a detachable camera device, according to an example implementation of the present subject matter; and

FIG. 5 illustrates a schematic of a detachable camera device coupled to an apparatus, according to an example implementation of the present subject matter.

### DETAILED DESCRIPTION

A detachable webcam, also referred to as webcam, includes a camera to capture images and an interface for communicating with an apparatus to which the webcam may be coupled. To capture images of an object, the webcam has to be manually adjusted, for example, by rotating, so that the lens of the camera faces the object. Alternatively, the object has to be re-positioned to be brought into the field of view of the camera. The manual adjustment may be cumbersome and may cause interruptions, for example, during video recording.

The webcam may also include a light source associated with the camera to provide light in low-light settings. The light source associated with the camera provides light when the camera is being used, for example, when an image is captured. However, the light source may not be usable without turning on the camera. Thus, an external light source may additionally be used, for example, to provide light on a keyboard associated with the apparatus to which the webcam is coupled.

Further, on turning the camera ON, the area illuminated by the light source of the webcam may not be sufficient for a task being performed. For example, if a person is recording a video for demonstrating use of an object, the light from the light source may not be sufficient to capture both the person and the object clearly. In such cases, external light sources may have to be used.

Aspects of the present subject matter relate to detachable camera devices which comprise a camera and an illumination module, where the camera and the illumination module may be controlled independently based on user inputs obtained from an apparatus to which the device is coupled. For ease of discussion, a detachable camera device is also referred to as a device hereinafter.

In one example, a device may include a magnetic coupler to detachably couple the device to an apparatus. The device can also include a camera, a drive system coupled to the camera to position the camera, and an illumination module to provide light. A controller in the device can be connected to the illumination module, the camera, and the drive system. The controller can receive a first signal corresponding to user inputs from the apparatus. For example, a Graphical User Interface (GUI) can be provided by the apparatus and the user can provide inputs on the GUI. Based on the first signal, the controller can control the illumination module, the camera, and the drive system.

Controlling the camera may include positioning the camera using the drive system and capturing images by the camera. In one example, the drive system can include a motor to move the camera. Controlling the illumination module may include controlling the intensity of illumination provided. In one example, the illumination module may include an array of light sources that may illuminate a region overlapping with a field of view of the camera of the device for capturing relatively high-quality images.

In various examples of the present subject matter, the number of cameras and the arrangement of light sources in the illumination module may be varied based on the application. Further, the illumination module may be controlled independent of the camera. In one example, the device may be coupled to the apparatus at an angle and the illumination module may be used to illuminate a keyboard or other articles placed near a base of the apparatus. The illumination module of the device may therefore be used independent of the camera, for example, as a reading light.

Thus, the present subject matter provides for more user friendly and less disruptive control of the camera and the illumination module of the device. It allows capture of relatively high-quality images using the lighting provided by the illumination module without using external light sources. The independent control of the camera and the illumination module also provides flexibility in operation of the device.

The following description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

Example implementations of the present subject matter are described with regard to personal computers (PCs) and laptop computers. Although not described, it will be understood that the implementations of the present subject matter can be used with other types of devices as well, such as, tablets, smartphone devices, and the like.

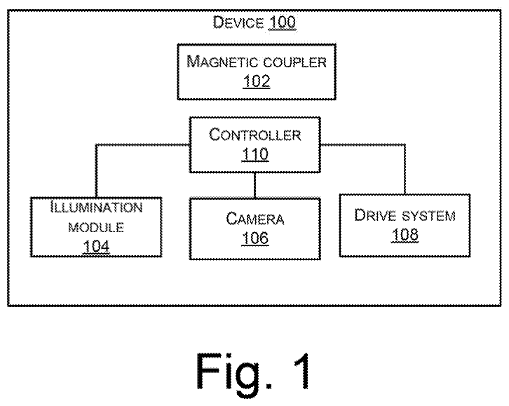

FIG. 1 illustrates an example detachable camera device 100, according to an example implementation of the present subject matter. The detachable camera device 100 is hereinafter also referred to as device 100. The device 100 comprises a magnetic coupler 102, an illumination module 104, a camera 106, a drive system 108, and a controller 110.

The magnetic coupler 102 can be used to detachably couple the device 100 to an apparatus, for example, on a frame member of the apparatus. The apparatus may be a desktop computer, a laptop, and the like. The number of magnetic couplers provided in the device 100 may be varied. The magnetic coupler 102 may be, for example, a protrusion or plug that may fit in a complementary cavity or socket provided in the apparatus. The protrusion or plug may include a magnet while the cavity or socket may include a ferromagnetic material. Hence, when the magnetic coupler 102 of the device 100 is brought in contact with the socket of the apparatus, the magnetic coupler 102 attaches to and is retained in the socket, thereby detachably coupling the device 100 to the apparatus. For detaching the device 100, a user may exert a force on the device 100 to overcome the magnetic attachment force between the magnetic coupler 102 and the socket, thereby pulling apart the device 100 from the apparatus. In other example implementations, other magnetic couplers may also be used.

The illumination module 104 can comprise an array of light sources, for example, Light Emitting Diodes (LEDs). In one example, the illumination module 104 can illuminate a region including a field of view of the camera 106. Further, the illumination module 104 may provide illumination over a larger region than that captured by the camera 106. In one example, the device 100 may have an elongated structure with a length similar to the length of the side of the apparatus to which the device 100 is to be coupled. The illumination module may extend along the length of the device 100, i.e., the LEDs may be arranged across the length of the device 100, and may, therefore, provide illumination over a wider region than the field of view of the camera 106.

In one example, the camera 106 may be a Red-Green-Blue (RGB) camera or an infrared camera. In another example, the device 100 can include a first camera and a second camera. The first camera may be a Red-Green-Blue (RGB) camera or a visible light camera and the second camera may be an InfraRed (IR) camera. The RGB camera or the visible light camera can be used, for example, for presentation of objects, video calls, and the like. The IR camera can be used for security purposes, such as face recognition, or for three-dimensional (3D) imaging and the like.

The drive system 108 can be coupled to the camera 106 to position the camera 106 for capturing images. The position of the camera 106 refers to an orientation of the camera 106 where lens of the camera 106 faces an object for capture of images of the object. In one example, when the device 100 includes a first camera and a second camera, the drive system 108 may be coupled to the first camera, the second camera, or both the first and the second cameras. In another example, the drive system 108 can include a first drive system and a second drive system. The first drive system may be coupled to the first camera and a second drive system may be coupled to the second camera. In one example, the drive system 108 can comprise a first motor to move a coupled camera along a first axis and a second motor to move the coupled camera along a second axis. The first and the second motor may be a linear motor, a rotary motor, or a combination thereof. Accordingly, the camera may be moved linearly or rotated about an axis or both.

In one example, the first and second axes along which the motors move may be perpendicular to each other, such as an x-axis or horizontal axis and a y-axis or vertical axis. The x-axis may be the axis extending along a length of the device 100 and the y-axis may be the axis extending along a height of the device 100. For example, the first motor may move the coupled camera along the x-axis and the second motor may move the coupled camera along the y-axis. However, the first and second axis may be other axes, which may be inclined to each other. In one example, the camera may move linearly along the first axis and may rotate about the second axis.

In operation, upon the device 100 being coupled to an apparatus, the controller 110 can receive a first signal corresponding to user inputs from the apparatus and can control the illumination module 104, the camera 106, and the drive system 108 based on the first signal.

For this, the device 100 can include a set of connectors through which the controller 110 can receive the first signal corresponding to the user inputs from the apparatus. The set of connectors can couple to corresponding set of connectors of the apparatus to receive the first signal. A connector of the device 100 may be a connecting pin that can connect with a corresponding connecting pin of the apparatus for transferring signals between the apparatus and the device 100. In one example, a connector of the set of connectors may also be used to provide power to the device 100 from the apparatus.

Based on the first signal, the controller 110 can provide a control signal, for example, to the illumination module 104 to change an intensity of illumination, to the drive system to change a position of the camera 106, to the camera 106 to capture an image, or any combination thereof. On capture of an image by the camera 106, the controller 110 can receive a second signal corresponding to the image captured from the camera 106 and can transmit the second signal to the apparatus for display of the image on the apparatus or for further processing. In one example, the second signal can be transmitted through the set of connectors of the device 100 to the corresponding set of connectors of the apparatus.

In various other examples, the device 100 may include other components, such as speakers, microphones, and the like. The controller 110 can control such other components as well as based on user inputs received from the apparatus.

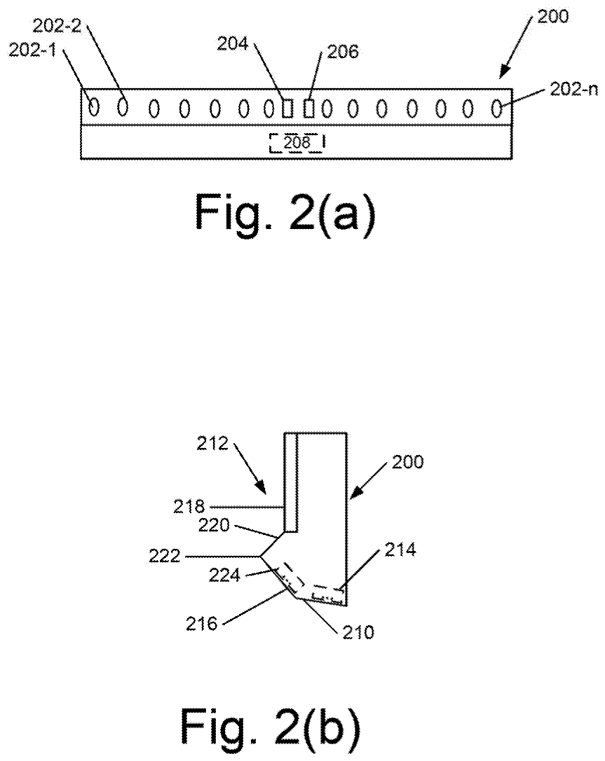

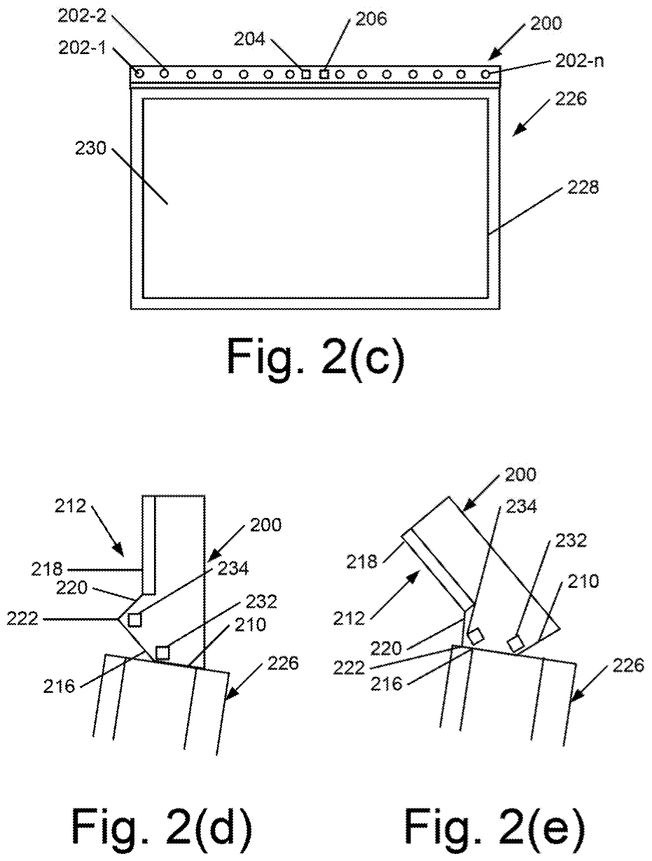

FIG. 2(a) depicts a front view of an example detachable camera device 200, according to another example implementation of the present subject matter. The detachable camera device 200 is hereinafter referred to as device 200. The device 200 may have an elongated structure, which can be coupled to an apparatus, such as a personal computer, a laptop, and the like. For example, the device 200 may be substantially cuboid or tubular or cuboid with beveled edges or of any other suitable form factor.

The device 200 comprises an array of light sources 202-1, 202-2 . . . 202-n, hereinafter referred to as array of light sources 202. The array of light sources 202 may form the illumination module 104 discussed above. In one example, the light sources 202 may be Light Emitting Diodes (LEDs). The array of light sources 202 may extend across a length of the device 200. Further, the light sources 202 may be placed in various arrangements, for example, linear, patterned, and the like.

In one example, the device 200 can comprise a first camera, such as a visible light camera 204, and a second camera, such as an infrared camera 206. The array of light sources 202 can be arranged to provide illumination over a region overlapping with the fields of view of the visible light camera 204 and the infrared camera 206.

A controller 208 is provided in the device 200 to control the array of light sources 202, the visible light camera 204, and the infrared camera 206 based on user inputs received from the apparatus. The user inputs may be used to position or orient the visible light camera 204 and the infrared camera 206.

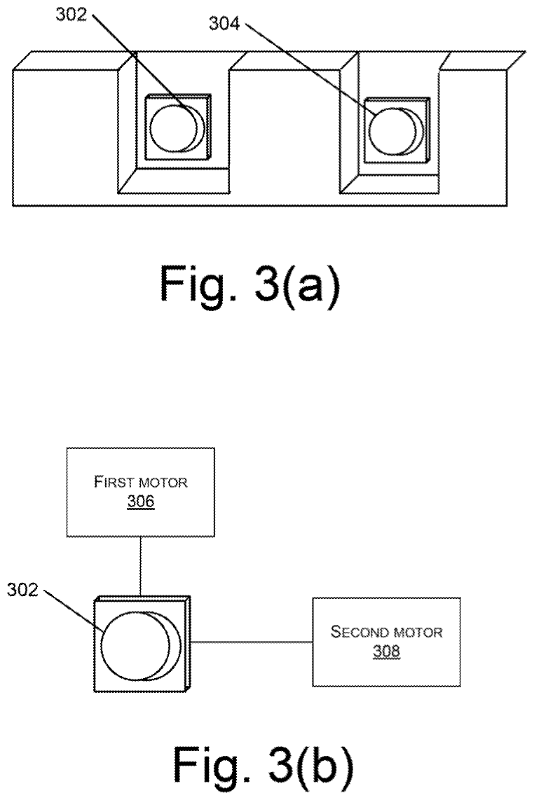

To position the visible light camera 204 and the infrared camera 206, the device 200 can comprise a first drive system (not shown in FIG. 2(a)) coupled to the visible light camera 204 and a second drive system (not shown in FIG. 2(a)) coupled to the infrared camera 206. The first drive system and the second drive system are discussed later with reference to FIG. 3(b). Both the first drive system and the second drive system are independently drivable by the controller 208 to change orientation of the visible light camera 204 and infrared camera 206, respectively, to position them based on user inputs received from the apparatus. To receive the user inputs from the apparatus, the device 200 can include a set of connector pins as shown in FIG. 2(b). The set of connector pins may be connectable to the apparatus.

FIG. 2(b) depicts a side-view of the device 200, according to another example implementation of the present subject matter. The device 200 can include a first side 210 and a chamfered side 212 adjacent to the first side 210. The first side may be the base of the device 200 while the chamfered side 212 may be the front side of the device 200. Additionally, the device 200 also includes a top side opposite to the first side 210 and a rear side opposite to the chamfered side 212. In a first position, the device 200 may be coupled to the apparatus at the first side 210 and, in a second position, the device 200 may be coupled to the apparatus at the chamfered side 212.

The first side 210 can comprise a first set of connector pins 214 which may be used to communicate between the device 200 and the apparatus when the device 200 is coupled to the apparatus on the first side 210. In one example, the first set of connector pins 214 may be electrical pins. The first set of connector pins 214 can be coupled to corresponding connector pins of the apparatus to obtain the first signal corresponding to user inputs from the apparatus. Although not shown in FIG. 2(b), either the first set of connector pins 214 or the corresponding connector pins of the apparatus may protrude to make electrical contact with the other. A first magnetic coupler can be provided on the first side 210 of the device 200 to couple the device 200 to the apparatus in the first position.

The chamfered side 212 can comprise an inclined surface 216 and a planar surface 218. The planar surface 218 can include the array of light sources 202, the visible light camera 204, and the infrared camera 206. The inclined surface 216 may include a second magnetic coupler to couple the device 200 to the apparatus in the second position.

In one example, the inclined surface 216 and the planar surface 218 may be adjacent to each other. In another example, an intermediate surface 220 may be provided between the inclined surface 216 and the planar surface 218. An edge 222 formed between the intermediate surface 220 and inclined surface 216 can form a projection from the planar surface 218. The edge 222 helps in providing an elevation, and thereby, increasing an area over which light may be provided, when the device 200 is coupled to the apparatus in the second position.

In one example, the device 200 may include a second set of connector pins 224 at the inclined surface 216 to communicate with the apparatus in the second position. Similar to the first set of connector pins 214, the second set of connector pins 224 may be electrical pins. Although not shown in FIG. 2(b), either the second set of connector pins 224 or the corresponding connector pins of the apparatus may protrude to make electrical contact with the other.

FIG. 2(c) depicts the device 200 coupled to an apparatus 226, according to another example implementation of the present subject matter. The apparatus 226 can include a frame member 228. The apparatus 226 may be a desktop computer, a laptop, and the like, and the frame member 228 can surround a display screen 230 of the apparatus 226. In one example, the frame member 228 may include a socket for detachably coupling to a magnetic coupler of the device 200 as discussed above.

While FIG. 2(c) depicts that the device 200 is disposed on a top portion of the frame member 228, it may be noted that the device 200 may be disposed on any portion of the frame member 228, including lateral and bottom portions of the frame member 228 in other implementations. Further, a length of the device 200, as shown in FIG. 2(c), is substantially same as the length of the top portion of the frame member. However, depending on an area to be illuminated, the length of the device 200 may be varied.

The apparatus 226 can provide an input interface to receive user inputs. For example, a Graphical User Interface (GUI) can be provided on the display screen 230 of the apparatus 226 to receive user inputs. In one example, the display screen 230 may be a touch screen user interface and the user inputs may be received via the touch screen. In other examples, the user input may be received via an input device, such as keyboard, mouse, and the like, connected to the apparatus 226. The device 200 may be disposed on the apparatus 226 in a first position as shown in FIG. 2(d) or in a second position as shown in FIG. 2(e).

FIG. 2(d) depicts the first position of the device 200, according to an example implementation of the present subject matter. In the first position, the device 200 may rest on the first side 210. A first magnetic coupler 232 on the first side 210 may be used to detachably couple the first side 210 to the apparatus 226. In the first position, the device 200 can be used for capturing images by the visible light camera 204, the infrared camera 206, or combination thereof. For the sake of brevity, the first set of connector pins 214 have not been shown in FIG. 2(d).

In operation, in the first position, the device 200 can be coupled to the frame member 228 of the apparatus 226 so that the first set of connector pins 214 is coupled with the apparatus 226, for example, with complementary connector pins on the apparatus. The controller 208 can receive the first signal corresponding to user inputs from the apparatus through the first set of connector pins 214.

Based on the user inputs received, the controller 208 can provide a control signal to the first drive system, the second drive system, or both, to change their orientations. The controller 208 can further provide another control signal to the visible light camera 204, the infrared camera 206, or both to capture images. Based on the first signal, the controller 208 can also provide a control signal to the array of light sources 202 to change an intensity of illumination provided by the array of light sources 202, for example, to increase or decrease the intensity of illumination.

In one example, the controller 208 may receive a second signal, from the visible light camera 204 or the infrared camera 206, corresponding to the captured images. The controller 208 can transfer the second signal to the apparatus for display on the display screen 230 or further processing, for example, to transfer over a network.

In one example, the visible light camera 204, the infrared camera 206, and the array of light sources 202 may be controlled for simultaneous image capture. In another example, one of the visible light camera 204 and the infrared camera 206 may be used. In yet another example, the array of light sources 202 may be controlled to provide light independent of operation of the visible light camera 204 and the infrared camera 206, for example, as a reading light. There may be various other example implementations possible, though not explicitly described, where the visible light camera 204, the infrared camera 206, and the array of light sources 202 may be used in different combinations as they can be controlled independently.

FIG. 2(e) depicts the second position of the device 200, according to another example implementation of the present subject matter. In the second position, the device 200 may rest on the inclined surface 216. In said example, the inclined surface 216 can comprise a second magnetic coupler 234 to detachably couple the inclined surface 216 of the device 200 to the apparatus.

The second position may be used to provide illumination independent of image capture, for example, to illuminate a keyboard or other area around a base of the apparatus.

In one example, the device 200 may communicate with the apparatus in the second position to control the array of light sources 202. For example, the device 200 can include the second set of connector pins 224, (shown in FIG. 2(b) but not shown in FIG. 2(e)), to communicate with the apparatus in the second position. The controller 208 may communicate with the apparatus 226 to receive the first signal corresponding to user inputs for varying the intensity of light provided by the array of the light sources 202. Based on the first signal corresponding to user inputs, the controller 208 can provide a control signal to the array of light sources 202 to change the intensity of illumination provided. Thus, the array of light sources 202 can provide light independent of the functioning of the visible light camera 204 and the infrared camera 206.

In another example, in the second position, the controller 208 may also control the visible light camera 204 and the infrared camera 206 for capturing images as discussed above with respect to the first position of the device 200.

FIG. 3(a) illustrates a sectional view of a detachable camera device, such as device 100 or device 200, depicting a set of cameras, according to another example implementation of the present subject matter. In one example, the set of cameras include a first camera 302 and a second camera 304. The first camera 302 can be a visible light camera and the second camera 304 can be an Infrared camera. As previously explained, the first camera 302 and the second camera 304 can be associated with a first drive system and a second drive system, respectively, to orient the respective cameras based on control signal provided by the controller.

FIG. 3(b) illustrates an example drive system, according to an example implementation of the present subject matter. The drive system may be the first drive system associated with the first camera 302 or the second drive system associated with the second camera 304. For sake of explanation, the first camera 302 and associated first drive system are shown.

The first drive system can comprise a first motor 306. The first motor 306 can cause movement of the first camera 302 along a first axis. The first drive system can further comprise a second motor 308. The second motor 308 can cause movement of the first camera 302 along a second axis. The first drive system can comprise other components, such as gears, racks, shafts, and the like, which are not explained herein for the sake of brevity.

The second camera 304 can also be associated with the first drive system in one example. In another example, the second camera 304 may be associated with an independent second drive system. Similar to the first drive system, the second drive system may also comprise a first motor and a second motor to move the second camera along a first axis and a second axis, respectively, based on user inputs provided through the apparatus to which the device is coupled. The first motor and the second motor of the first drive system and the second drive system may be linear or rotary to move the coupled camera linearly or to rotate or swivel the coupled camera.

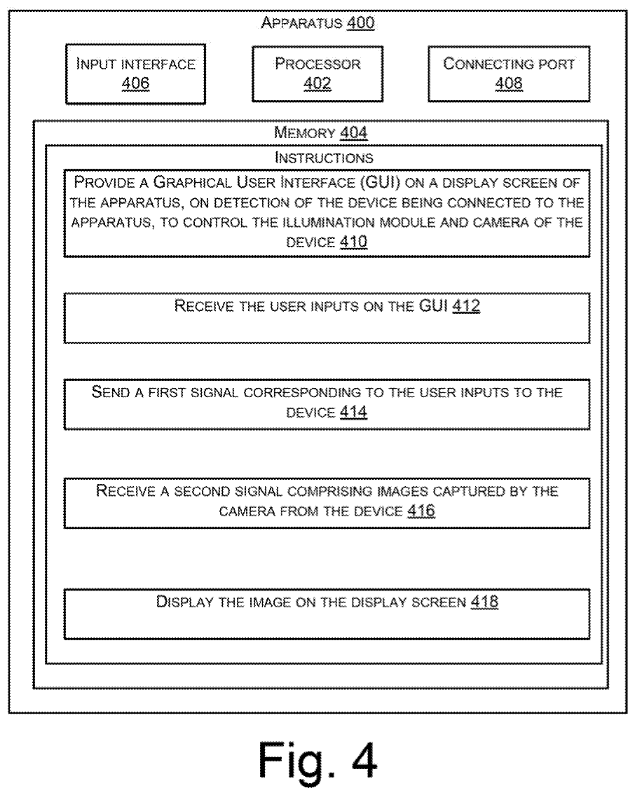

FIG. 4 illustrates an example apparatus 400, according to an example implementation of the present subject matter. The apparatus 400 may be a desktop computer, a laptop, and the like. The apparatus 400 can comprise a processor 402 and a memory 404 coupled to the processor 402.

The processor 402 may be implemented as microprocessors, microcomputers, microcontrollers, digital signal processors, central processing units, state machines, logic circuitries, and/or any devices that manipulate signals based on operational instructions. Among other capabilities, the processor 402 may fetch and execute computer-readable instructions included in the memory 404. The functions of the processor 402 may be provided through the use of dedicated hardware as well as hardware capable of executing machine readable instructions.

The memory 404 may include any non-transitory computer-readable medium including volatile memory (e.g., RAM), and/or non-volatile memory (e.g., EPROM, flash memory, Memristor, etc.). The memory 404 may also be an external memory unit, such as a flash drive, a compact disk drive, an external hard disk drive, or the like.

In addition to the processor 402 and the memory 404, the apparatus 400 may also include interface(s) and a data store (not shown in FIG. 4). The interface(s) may include a variety of machine readable instructions-based interfaces and hardware interfaces that allow interaction with a user and with other communication and computing devices, such as network entities, web servers, and external repositories, and peripheral devices. The data store may serve as a repository for storing data that may be fetched, processed, received, or created by the instructions.

The apparatus 400 can include an input interface 406 to receive user inputs. In one example, the input interface 406 may be a touch screen input interface provided on a display screen of the apparatus 400. In other examples, the input interface 406 may be a keyboard, a mouse, a joystick, or the like.

The apparatus 400 can also include a connecting port 408 to connect to a device and a coupler complementary to the magnetic coupler of the device to detachably couple to the device. In an example, the device may be device 100 comprising the illumination module 104, the camera 106, and the drive system 108. In another example, the device may be device 200 comprising the array of light sources 202, the visible light camera 204, the infrared camera 206, and drive systems for the cameras.

The connecting port 408 can comprise a plurality of pins, such as electrical pins. In one example, the plurality of pins can comprise a first pin to sense a side of the device at which the device is connected. The side of the device may be the inclined surface 216 or the first side 210. Based on the side sensed, the apparatus 400 can provide a Graphical User Interface (GUI) to receive user inputs. For example, if the side sensed is the first side 210, a first GUI can be provided through which the user can provide user inputs for adjusting orientation of the camera and for adjustment of intensity of light provided by the illumination module. In another example, if the side sensed is the inclined surface 216, a second GUI can be provided through which the user can adjust the intensity of light provided by the illumination module. In yet another example, if the side sensed is the inclined surface 216, the second GUI provided may allow for control of the illumination module and the visible light camera, but not the infrared camera.

In another example, the apparatus 400 may include a hall sensor in the coupler to identify that a magnetic coupler of the device has been coupled to the apparatus 400 and provide the GUI based on the identification.

The plurality of pins can also comprise a second pin to provide power to the device. Through the second pin, power signals can be provided to the device, for example, to power the controller, the camera, the illumination module, the drive system, and the like.

Further, a third pin can also be provided to communicate with the device. The third pin may be used to transmit the first signal corresponding to user inputs from the apparatus to the device and also for receiving second signal corresponding to captured images from the device to the apparatus 400. The plurality of pins can electrically couple to complementary pins in the first set of connector pins 214 or the second set of connector pins 224 of the device.

As previously explained, the memory 404 can store computer-readable instructions, hereinafter referred to as instructions, for implementing various operations using the apparatus, including controlling the device. The instructions may include, for example, instructions 410, instructions 412, instructions 414, instructions 416, and instructions 418.

In operation, on execution of instructions 410, the GUI can be provided on the display screen of the apparatus 400. The GUI can be provided, for example, on detection of the device being connected to the apparatus 400. The apparatus 400 may detect the device based on the hall sensor or the first pin of connecting pins as discussed above.

On execution of instructions 412, user inputs can be received on the GUI for controlling the device. For example, the user inputs may include inputs for one or more of changing orientation of the camera, changing intensity of illumination provided, and capturing an image by the camera.

On execution of instructions 414, a first signal corresponding to the user inputs can be sent to the device. Based on the first signal, the controller of the device can control the illumination module to change an intensity of illumination, can control the drive system to change a position of the camera, can control the camera to capture an image, or a combination thereof.

Further, if an image is captured, a second signal corresponding to the image captured by the camera of the device can be received by the apparatus 400, on execution of instructions 416. The second signal can be received by the apparatus 400, for example, through the third pin of the connector ports.

On execution of instructions 418, the image corresponding to the second signal can be displayed on the display screen. In other examples, the image may be further processed, for example, sent over a communication network to another apparatus.

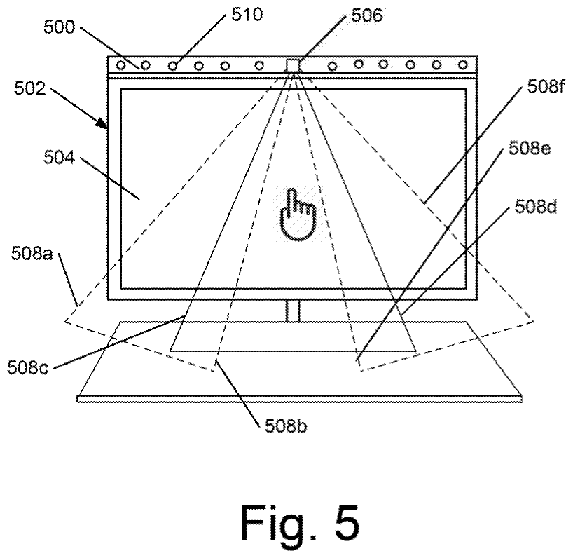

FIG. 5 illustrates a schematic of a device 500 coupled to an apparatus 502, according to an example implementation of the present subject matter. The device 500 may be the device 100 or 200 and the apparatus 502 may be apparatus 226 or 400.

The apparatus 502 can include a touch screen input interface on a display screen 504 of the apparatus 400. Based on the user inputs received on the touch screen input interface, the camera 506 can be oriented and positioned to capture images in a field of view. For example, the field of view indicated by lines 508a-508b indicate a first field of view when the camera is in a first orientation; lines 508c-508d indicate a second field of view when the camera is in a second orientation; and lines 508e-508f indicate a third field of view when the camera is in a third orientation. Other orientations and corresponding fields of view are possible. The orientation may be changed based on the user input received through the touch screen input interface of the apparatus 502. While FIG. 5 depicts a single camera 506, multiple cameras may also be provided on the device and controlled individually based on the user inputs, as explained previously.

An array of light sources 510 can be used to provide light for illuminating the field of view for image capture by the camera 506 or for providing illumination independent of the camera 506. The array of light sources 510 may also provide illumination over a region larger than the field of view of the camera 506, and thereby external light sources may not have to be used.

The preceding description has been presented to illustrate and describe examples of the principles described. This description is not intended to be exhaustive. Many modifications and variations are possible in light of the above teaching.

1. A device comprising:
a magnetic coupler to detachably couple the device to an apparatus;
an illumination module;
a camera;
a drive system coupled to the camera to position the camera; and
a controller connected to the illumination module, the camera, and the drive system, wherein the controller is to:
receive a first signal corresponding to user inputs from the apparatus; and
control the illumination module, the camera, and the drive system based on the first signal.

2. The device of claim 1, comprising a first camera and a second camera, wherein the drive system is coupled to the first camera, the second camera, or both the first and second cameras, and wherein the drive system comprises a first motor to move a coupled camera along a first axis and a second motor to move the coupled camera along a second axis.

3. The device of claim 2, wherein the first camera is a Red-Green-Blue (RGB) camera and the second camera is an InfraRed (IR) camera.

4. The device of claim 1, wherein the drive system comprises a linear motor, a rotary motor, or a combination thereof.

5. The device of claim 1, wherein the illumination module comprises Light Emitting Diodes (LEDs).

6. The device of claim 1, wherein the controller is to provide, based on the first signal, a control signal to:
the illumination module to change an intensity of illumination;
the drive system to change a position of the camera;
the camera to capture an image; or
a combination thereof.

7. The device of claim 6, wherein the controller is to receive a second signal corresponding to the image captured by the camera and transmit the second signal to the apparatus for display of the image.

8. A device comprising:
a first side having a set of connector pins connectable to an apparatus;
a chamfered side adjacent to the first side, wherein the chamfered side comprises an inclined surface and a planar surface;
an array of light sources, a visible light camera, and an infrared camera provided on the planar surface; and
a controller to control the array of light sources, the visible light camera, and the infrared camera based on user inputs received from the apparatus through the set of connector pins.

9. The device of claim 8, comprising
a first drive system coupled to the visible light camera and drivable by the controller to change orientation of the visible light camera.

10. The device of claim 8 comprising:
a second drive system coupled to the infrared camera and drivable by the controller to change orientation of the infrared camera.

11. The device of claim 8, further comprising a first magnetic coupler on the first side and a second magnetic coupler on the inclined surface to detachably couple the first side or the inclined surface of the device to the apparatus.

12. The device of claim 11, wherein the array of light sources is arranged to provide illumination over a region overlapping with fields of view of the visible light camera and the infrared camera.

13. An apparatus comprising:
a processor;
an input interface to receive user inputs;
a connecting port to detachably connect to a device, the device comprising an illumination module and a camera; and
a memory comprising instructions executable by the processor to:
provide a graphical user interface (GUI) on a display screen of the apparatus, on detection of the device being connected to the apparatus, to control the illumination module and the camera of the device;
receive the user inputs on the GUI;
send a first signal corresponding to the user inputs to the device;
receive a second signal comprising images captured by the camera from the device; and
display the images on the display screen.

14. The apparatus of claim 13, wherein the input interface is a touch screen input interface provided on the display screen.

15. The apparatus of claim 13, wherein the connecting port comprises:
a first pin to sense a side of the device at which the device and the apparatus are coupled, wherein the GUI is provided based on the side sensed;
a second pin to provide power to the device; and
a third pin to communicate with the device.
